(19) United States
(12) Patent Application Publication
(10) Pub. No.: US 2026/0252267 A1
(43) Pub. Date: Aug. 27, 2026

(54) APPLICATION-AWARE QUALITY OF SERVICE IN A DISTRIBUTED STORAGE SYSTEM

(71) Applicant: Dell Products L.P., Round Rock, TX (US)

(72) Inventors: Sanjib Mallick, Bengaluru (IN); Koundinya Koorapati, Bengaluru (IN); Usha B. Narasappa, Bengaluru (IN)

(21) Appl. No.: 19/060,011

(22) Filed: Feb. 21, 2025

(51) Int. Cl. G06F 3/06

(52) U.S. Cl. CPC G06F 3/0659; G06F 3/061; G06F 3/067; G06F 3/0688

(57) ABSTRACT

An apparatus comprises at least one processing device configured to implement multiple queues for respective different service levels in a storage target of a storage system. For each of a plurality of input-output operations received in the storage target from at least one host device, the at least one processing device determines application-identifying information for the input-output operation, identifies a particular one of the queues based at least in part on the application-identifying information for the input-output operation, and enqueues the input-output operation in the particular identified queue. The at least one processing device also monitors service times for input-output operations processed from the queues, and responsive to detection of an above-threshold deviation from a specified service time objective for a given one of queues, adjusts one or more characteristics of a processing resource time slice allocated for processing of input-output operations from the given one of the queues.

### FIELD

The field relates generally to information processing systems, and more particularly to storage in information processing systems.

### BACKGROUND

Information processing systems often include distributed storage systems comprising multiple storage nodes. These distributed storage systems may be dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. For applications running on a host that utilizes the software-defined storage system, such a storage system provides a logical storage object view to allow a given application to store and access data, without the application being aware that the data is being dynamically distributed among different storage nodes. In these and other storage systems, it can be unduly difficult to achieve desired service levels across certain processing resources of one or more storage targets of the storage nodes, particularly when using advanced storage access protocols such as Non-Volatile Memory Express (NVMe) over Fabrics, also referred to as NVMe-oF, or NVMe over Transmission Control Protocol (TCP), also referred to as NVMe/TCP. For example, conventional approaches can lead to sub-optimal arrangements when processing input-output (IO) operations utilizing certain resources of one or more storage targets, thereby adversely impacting storage system performance.

### SUMMARY

Illustrative embodiments disclosed herein provide techniques for application-aware quality of service (QoS) in a distributed storage system. Such techniques in some embodiments can provide improved processing of IO operations, for example, in a software-defined storage system or other distributed storage system comprising one or more clusters of storage nodes. In some embodiments, each such storage node implements at least one storage server.

The disclosed techniques in some embodiments advantageously facilitate highly efficient operation of multiple distinct storage servers implemented in the storage nodes, in processing IO operations received from different applications of multiple hosts that share access to the storage servers of those storage nodes.

For example, some embodiments prevent large bursts of IOs generated by a low-priority application from unduly delaying the processing of more critical IO operations generated by a high-priority application, where the two applications share access to at least one storage server of at least one storage node. Similar operating enhancements are provided in numerous other contexts, leading to significantly improved overall storage system performance.

Although some embodiments are described herein in the context of an NVMe-oF or NVMe/TCP access protocol in a software-defined storage system, it is to be appreciated that other embodiments can be implemented in other types of storage systems using other storage access protocols.

In one embodiment, an apparatus comprises at least one processing device that includes a processor coupled to a memory. The at least one processing device is configured to implement multiple queues for respective different service levels in a storage target of a storage system. For each of a plurality of IO operations received in the storage target from at least one host device, the at least one processing device determines application-identifying information for the IO operation, identifies a particular one of the queues based at least in part on the application-identifying information for the IO operation, and enqueues the IO operation in the particular identified queue. The at least one processing device is further configured to monitor service times for IO operations processed from the queues, and responsive to detection of an above-threshold deviation from a specified service time objective for a given one of queues, to adjust one or more characteristics of a processing resource time slice allocated for processing of IO operations from the given one of the queues.

In some embodiments, the application-identifying information for the IO operation comprises at least one of an application identifier, a process identifier, a user identifier and a group identifier. Additional or alternative application-identifying information can be used in other embodiments.

The application-identifying information in some embodiments is illustratively configured to allow the storage target to distinguish between IO operations generated by respective different applications executing on the at least one host device.

In some embodiments, the at least one host device implements at least one storage data client that associates each of the IO operations with its respective corresponding application-identifying information.

The different service levels for respective ones of the queues in some embodiments illustratively comprise respective different IO processing criticality levels.

In some embodiments, the at least one processing device is further configured to assign different processing resource time slices to different ones of the queues.

Additionally or alternatively, adjusting one or more characteristics of a processing resource time slice allocated for processing of IO from the given one of the queues comprises adjusting a number of processing threads and/or a number of processor cycles of the processing resource time slice.

In some embodiments, monitoring service times for IO operations processed from the queues comprises determining for each of the queues an average service time over a designated time period. Additional or alternative monitoring arrangements can be implemented in other embodiments, illustratively utilizing average service times, maximum service times and/or other QoS metrics.

Such features of illustrative embodiments are examples only, and should not be viewed as limiting in any way.

These and other illustrative embodiments include, without limitation, apparatus, systems, methods and computer program products comprising processor-readable storage media.

### BRIEF DESCRIPTION OF THE DRAWINGS

FIG. 1 is a block diagram of an information processing system incorporating functionality for application-aware QoS in a distributed storage system in an illustrative embodiment.

FIG. 2 is a flow diagram of a process for application-aware QoS in a distributed storage system in an illustrative embodiment.

FIG. 3 shows another example of an information processing system incorporating functionality for application-aware QoS in a distributed storage system in an illustrative embodiment.

FIG. 4 shows a further example of an information processing system incorporating functionality for application-aware QoS in a distributed storage system in an illustrative embodiment.

FIG. 5 shows example pseudocode for associating application-identifying information with IO operations in a host device in an illustrative embodiment.

FIG. 6 shows an example queuing arrangement implemented in a storage node of a distributed storage system in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

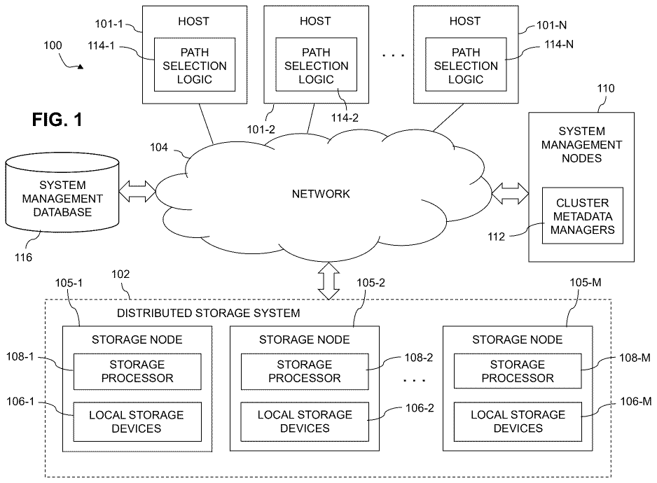

FIG. 1 shows an information processing system 100 configured in accordance with an illustrative embodiment. The information processing system 100 comprises a plurality of hosts 101-1, 101-2, . . . 101-N, collectively referred to herein as hosts 101, and a distributed storage system 102 shared by the hosts 101. The hosts 101 and distributed storage system 102 in this embodiment are configured to communicate with one another via a network 104 that illustratively utilizes protocols such as Transmission Control Protocol (TCP) and Internet Protocol (IP), and is therefore referred to herein as a TCP/IP network, although it is to be appreciated that the network 104 can operate using additional or alternative protocols. In some embodiments, the network 104 comprises a storage area network (SAN) that includes one or more Fibre Channel (FC) switches, Ethernet switches or other types of switch fabrics.

The system 100 is configured to implement application-aware QoS functionality of the type disclosed herein, utilizing hosts 101 and distributed storage system 102, and possibly additional or alternative components, as will be described in more detail below. The hosts 101 illustratively share access to the distributed storage system 102, and in some embodiments the hosts 101 and/or applications executing on the hosts 101 may be referred to as respective “tenants” of the distributed storage system 102.

The hosts 101 are also referred to herein as respective “host devices.” It should be noted that terms such as “host” and “host device” as used herein are intended to be broadly construed, so as to encompass, for example, a host system which may comprise multiple distinct devices of various types. A given one of the hosts 101 in some embodiments can therefore comprise, for example, at least one server, as well as a wide variety of additional or alternative types and arrangements of processing devices.

The distributed storage system 102 more particularly comprises a plurality of storage nodes 105-1, 105-2, . . . 105-M, collectively referred to herein as storage nodes 105. The values N and M in this embodiment denote arbitrary integer values that in the figure are illustrated as being greater than or equal to three, although other values such as N=1, N=2, M=1 or M=2 can be used in other embodiments.

The storage nodes 105 collectively form the distributed storage system 102, which is just one possible example of what is generally referred to herein as a “distributed storage system.” Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the distributed storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105. Additionally or alternatively, logical blocks of one or more logical storage volumes may each be accessible via only a subset of the storage nodes 105. For example, a given one of the storage nodes 105 may store an entire logical storage volume, or multiple entire logical storage volumes.

Other types of distributed storage systems can be used in other embodiments. For example, distributed storage system 102 can comprise multiple distinct storage arrays, such as a production storage array and a backup storage array, possibly deployed at different locations. Each such storage array can comprise one or more of the storage nodes 105, and may be implemented as at least a portion of a cluster of multiple ones of the storage nodes 105.

The distributed storage system 102 in some embodiments comprises multiple clusters, with each such cluster comprising a distinct subset of the storage nodes 105. For example, the distributed storage system 102 can comprise a source cluster and a target cluster, each comprising a different subset of the storage nodes 105, where the source cluster initiates data services, such as replication, migration and/or copying, to be carried out using storage targets of the storage nodes of the second cluster.

Accordingly, in some embodiments, one or more of the storage nodes 105 may each be viewed as comprising at least a portion of a separate storage array or storage cluster with its own logical address space or other logical identifier space. Alternatively, the storage nodes 105 can be viewed as collectively comprising one or more storage arrays. The term “storage node” as used herein is therefore intended to be broadly construed.

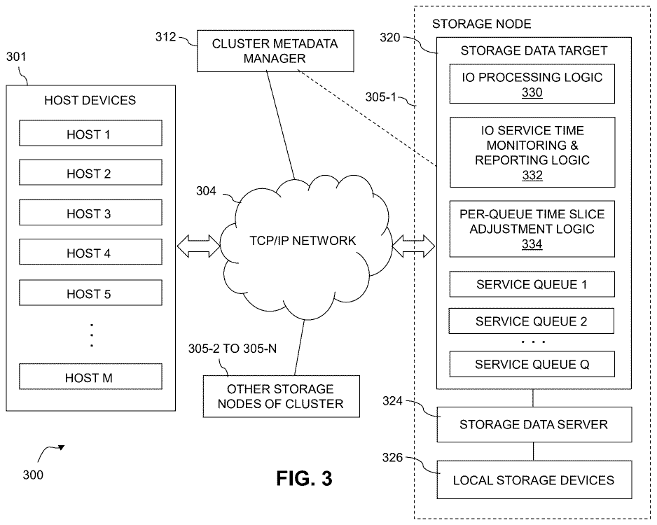

In some embodiments, the distributed storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments. Examples of such software-defined storage systems will be described in more detail below in conjunction with FIGS. 3 through 6.

It is to be appreciated, however, that techniques disclosed herein can be implemented in other embodiments in stand-alone storage arrays or other types of storage systems that are not distributed across multiple storage nodes. The disclosed techniques are therefore applicable to a wide variety of different types of storage systems. The distributed storage system 102 is just one illustrative example.

In the distributed storage system 102, each of the storage nodes 105 is illustratively configured to interact with one or more of the hosts 101. The hosts 101 illustratively comprise servers or other types of computers of an enterprise computer system, cloud-based computer system or other arrangement of multiple compute nodes, each associated with one or more system users.

The hosts 101 in some embodiments illustratively provide compute services such as execution of one or more applications on behalf of each of one or more users associated with respective ones of the hosts 101. Such applications illustratively generate input-output (IO) operations that are processed by a corresponding one of the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The IO operations that are currently being processed in the distributed storage system 102 in some embodiments are referred to herein as outstanding IOs that have been admitted by the storage nodes 105 to further processing within the system 100. The storage nodes 105 are illustratively configured to queue IO operations arriving from one or more of the hosts 101 in one or more sets of storage-side IO queues, to be distinguished from host-side IO queues referred to elsewhere herein. In some embodiments, each of the storage nodes 105 comprises one or more NVMe targets or other types of targets of the distributed storage system 102, and each such target is configured with a plurality of storage-side IO queues. Each such storage-side IO queue or set of storage-side IO queues may have at least one corresponding TCP connection or other type of network connection with one or more of the hosts 101. Such IO queues and network connections in some embodiments may be considered examples of “network resources” as that term is broadly used herein.

In some embodiments, a given set of storage-side IO queues of the type noted above may be further configured to support application-aware QoS as disclosed herein, illustratively by implementing a separate queue for each of a plurality of different service levels. Other types and arrangements of one or more sets of queues can be used in each of the storage nodes 105 in other embodiments.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms. In the case of separate processing platforms, there may be a single storage node per processing platform or multiple storage nodes per processing platform.

The hosts 101 are illustratively configured to write data to and read data from the distributed storage system 102 comprising storage nodes 105 in accordance with applications executing on those hosts 101 for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments therefore comprises one or more additional networks other than network 104 each comprising processing devices configured to communicate using TCP, IP and/or other communication protocols.

As a more particular example, some embodiments may utilize one or more high-speed local networks in which associated processing devices communicate with one another utilizing Peripheral Component Interconnect express (PCIe) interface cards of those devices, that support networking protocols such as InfiniBand or Fibre Channel, in addition to or in place of TCP/IP. Numerous alternative networking arrangements are possible in a given embodiment, as will be appreciated by those skilled in the art. Additional examples include remote direct memory access (RDMA) over Converged Ethernet (RoCE) or RDMA over iWARP.

The first storage node 105-1 comprises a plurality of storage devices 106-1 and an associated storage processor 108-1. The storage devices 106-1 illustratively store metadata pages and user data pages associated with one or more storage volumes of the distributed storage system 102. The storage volumes illustratively comprise respective logical units (LUNs) or other types of logical storage volumes (e.g., NVMe namespaces). The storage devices 106-1 in some embodiments more particularly comprise local persistent storage devices of the first storage node 105-1. Such persistent storage devices are local to the first storage node 105-1, but remote from the second storage node 105-2, the storage node 105-M and any other ones of other storage nodes 105.

Each of the other storage nodes 105-2 through 105-M is assumed to be configured in a manner similar to that described above for the first storage node 105-1. Accordingly, by way of example, storage node 105-2 comprises a plurality of storage devices 106-2 and an associated storage processor 108-2, and storage node 105-M comprises a plurality of storage devices 106-M and an associated storage processor 108-M.

As indicated previously, the storage devices 106-2 through 106-M illustratively store metadata pages and user data pages associated with one or more storage volumes of the distributed storage system 102, such as the above-noted LUNs or other types of logical storage volumes. The storage devices 106-2 in some embodiments more particularly comprise local persistent storage devices of the storage node 105-2. Such persistent storage devices are local to the storage node 105-2, but remote from the first storage node 105-1, the storage node 105-M, and any other ones of the storage nodes 105. Similarly, the storage devices 106-M in some embodiments more particularly comprise local persistent storage devices of the storage node 105-M. Such persistent storage devices are local to the storage node 105-M, but remote from the first storage node 105-1, the second storage node 105-2, and any other ones of the storage nodes 105.

The local persistent storage of a given one of the storage nodes 105 illustratively comprises the particular local persistent storage devices that are implemented in or otherwise associated with that storage node.

In the FIG. 1 embodiment, the distributed storage system 102 comprises storage processors 108 and corresponding sets of storage devices 106, and may include additional or alternative components, such as sets of local caches.

The storage processors 108 illustratively control the processing of IO operations received in the distributed storage system 102 from the hosts 101. For example, the storage processors 108 illustratively manage the processing of read and write commands directed by the MPIO drivers of the hosts 101 to particular ones of the storage devices 106. The storage processors 108 can be implemented as respective storage controllers, directors or other storage system components configured to control storage system operations relating to processing of IO operations. In some embodiments, each of the storage processors 108 has a different one of the above-noted local caches associated therewith, although numerous alternative arrangements are possible.

The storage processors 108 of the storage nodes 105 may include additional modules and other components typically found in conventional implementations of storage processors and storage systems, although such additional modules and other components are omitted from the figure for clarity and simplicity of illustration.

For example, the storage processors 108 in some embodiments can comprise or be otherwise associated with one or more write caches and one or more write cache journals, both also illustratively distributed across the storage nodes 105 of the distributed storage system. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include, for example, non-volatile random access memory (NVRAM), phase-change RAM (PC-RAM), magnetic RAM (MRAM), resistive RAM, and spin torque transfer magneto-resistive RAM (STT-MRAM). These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of local persistent storage devices that may be used to implement at least a portion of the storage devices 106 of the storage nodes 105 of the distributed storage system of FIG. 1.

In some embodiments, the storage nodes 105 collectively provide a distributed storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the hosts 101 and the storage nodes 105 comprise NVMe commands of an NVMe storage access protocol, for example, as described in the NVM Express Base Specification, Revision 2.0c, October 2022, and its associated NVM Express Command Set Specification and NVM Express TCP Transport Specification, all of which are incorporated by reference herein. Other examples of NVMe storage access protocols that may be utilized in illustrative embodiments disclosed herein include NVMe over Fabrics, also referred to herein as NVMe-oF, and NVMe over TCP, also referred to herein as NVMe/TCP. Other embodiments can utilize other types of storage access protocols, including, for example, NVMe over Fibre Channel, also referred to herein as NVMe/FC.

As another example, communications between the hosts 101 and the storage nodes 105 in some embodiments can be implemented using Small Computer System Interface (SCSI) commands and the Internet SCSI (iSCSI) protocol.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

Some embodiments disclosed herein are configured to utilize one or more RAID arrangements to store data across the storage devices 106 in each of one or more of the storage nodes 105 of the distributed storage system 102. Other embodiments can utilize other data protection techniques, such as, for example, Erasure Coding (EC), instead of one or more RAID arrangements.

The RAID arrangement can comprise, for example, a RAID 5 arrangement supporting recovery from a failure of a single one of the plurality of storage devices, a RAID 6 arrangement supporting recovery from simultaneous failure of up to two of the storage devices, or another type of RAID arrangement. For example, some embodiments can utilize RAID arrangements with redundancy higher than two.

The term “RAID arrangement” as used herein is intended to be broadly construed, and should not be viewed as limited to RAID 5, RAID 6 or other parity RAID arrangements. For example, a RAID arrangement in some embodiments can comprise combinations of multiple instances of distinct RAID approaches, such as a mixture of multiple distinct RAID types (e.g., RAID 1 and RAID 6) over the same set of storage devices, or a mixture of multiple stripe sets of different instances of one RAID type (e.g., two separate instances of RAID 5) over the same set of storage devices. Other types of parity RAID techniques and/or non-parity RAID techniques can be used in other embodiments.

Such a RAID arrangement is illustratively established by the storage processors 108 of the respective storage nodes 105. The storage devices 106 in the context of RAID arrangements herein are also referred to as “disks” or “drives.” A given such RAID arrangement may also be referred to in some embodiments herein as a “RAID array.”

The RAID arrangement used in an illustrative embodiment includes a plurality of devices, each illustratively a different physical storage device of the storage devices 106. Multiple such physical storage devices are typically utilized to store data of a given LUN or other logical storage volume in the distributed storage system. For example, data pages or other data blocks of a given LUN or other logical storage volume can be “striped” along with its corresponding parity information across multiple ones of the devices in the RAID arrangement in accordance with RAID 5 or RAID 6 techniques.

A given RAID 5 arrangement defines block-level striping with single distributed parity and provides fault tolerance of a single drive failure, so that the array continues to operate with a single failed drive, irrespective of which drive fails. For example, in a conventional RAID 5 arrangement, each stripe includes multiple data blocks as well as a corresponding p parity block. The p parity blocks are associated with respective row parity information computed using well-known RAID 5techniques. The data and parity blocks are distributed over the devices to support the above-noted single distributed parity and its associated fault tolerance.

A given RAID 6 arrangement defines block-level striping with double distributed parity and provides fault tolerance of up to two drive failures, so that the array continues to operate with up to two failed drives, irrespective of which two drives fail. For example, in a conventional RAID 6 arrangement, each stripe includes multiple data blocks as well as corresponding p and q parity blocks. The p and q parity blocks are associated with respective row parity information and diagonal parity information computed using well-known RAID 6 techniques. The data and parity blocks are distributed over the devices to collectively provide a diagonal-based configuration for the p and q parity information, so as to support the above-noted double distributed parity and its associated fault tolerance.

In such RAID arrangements, the parity blocks are typically not read unless needed for a rebuild process triggered by one or more storage device failures.

These and other references herein to RAID 5, RAID 6 and other particular RAID arrangements are only examples, and numerous other RAID arrangements can be used in other embodiments. Also, other embodiments can store data across the storage devices 106 of the storage nodes 105 without using RAID arrangements.

In some embodiments, the storage nodes 105 of the distributed storage system of FIG. 1 are connected to each other in a full mesh network, and are collectively managed by a system manager. A given set of local persistent storage devices or other storage devices 106 on a given one of the storage nodes 105 is illustratively implemented in a disk array enclosure (DAE) or other type of storage array enclosure of that storage node. Each of the storage nodes 105 illustratively comprises a central processing unit (CPU) or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, two or more of the storage nodes 105 in some embodiments are arranged together in multiple groups, with each such group being coupled to a different DAE comprising multiple drives, and each node in a group being connected to the DAE and to each drive through a separate connection. The system manager may be running on one of the nodes of a first one of the groups of the distributed storage system. Again, numerous other arrangements of the storage nodes are possible in a given distributed storage system as disclosed herein.

The system 100 as shown further comprises a plurality of system management nodes 110 that are illustratively configured to provide system management functionality of the type noted above. Such functionality in the present embodiment illustratively further involves utilization of cluster metadata managers 112 and a system management database 116. In some embodiments, at least portions of the system management nodes 110 and their associated cluster metadata managers 112 are distributed over the storage nodes 105. For example, a designated subset of the storage nodes 105 can each be configured to include a corresponding one of the cluster metadata managers 112. Other system management functionality provided by system management nodes 110 can be similarly distributed over a subset of the storage nodes 105. In some embodiments, the cluster metadata managers 112 are implemented in or otherwise associated with respective control plane servers or other types of system management entities.

The system management database 116 stores configuration and operation information of the system 100 and portions thereof are illustratively accessible to various system administrators such as host administrators and storage administrators.

The hosts 101-1, 101-2, . . . 101-N include respective instances of path selection logic 114-1, 114-2, . . . 114-N. Such instances of path selection logic 114 are illustratively utilized in supporting functionality for application-aware QoS in the distributed storage system 102, illustratively through interaction with IO processing logic instances implemented in respective ones of the storage processors 108 of the storage nodes 105, as described in more detail below.

In some embodiments, each of the storage nodes 105 of the distributed storage system 102 is assumed to comprise multiple controllers associated with a corresponding storage target of that storage node, also referred to herein as simply a “target.” Such a target as that term is broadly used herein is illustratively a destination end of one or more paths from one or more of the hosts 101 to the storage node, and may comprise, for example, an NVMe subsystem of the storage node, although other types of targets can be used in other embodiments. It should be noted that different types of targets may be present in NVMe embodiments than are present in other embodiments that use other storage access protocols, such as SCSI embodiments. Accordingly, the types of targets that may be implemented in a given embodiment can vary depending upon the particular storage access protocol being utilized in that embodiment, and/or other factors. Similarly, the types of initiators can vary depending upon the particular storage access protocol, and/or other factors. Again, terms such as “initiator” and “target” as used herein are intended to be broadly construed, and should not be viewed as being limited in any way to particular types of components associated with any particular storage access protocol.

The paths that are selected by instances of path selection logic 114 of the hosts 101 for delivering IO operations from the hosts 101 to the distributed storage system 102 are associated with respective initiator-target pairs, as described in more detail elsewhere herein.

In some embodiments, IO operations are processed in the hosts 101 utilizing their respective instances of path selection logic 114 in the following manner. A given one of the hosts 101 establishes a plurality of paths between at least one initiator of the given host and a plurality of targets of respective storage nodes 105 of the distributed storage system 102. For each of a plurality of IO operations generated in the given host for delivery to the distributed storage system 102, the host selects a path to a particular target, and sends the IO operation to the corresponding storage node over the selected path.

The given host above is an example of what is more generally referred to herein as “at least one processing device” that includes a processor coupled to a memory. The storage nodes 105 of the distributed storage system 102 are also examples of “at least one processing device” as that term is broadly used herein.

It is to be appreciated that path selection as disclosed herein can be performed independently by each of the hosts 101, illustratively utilizing their respective instances of path selection logic 114, as indicated above, with possible involvement of additional or alternative system components.

In some embodiments, the initiator of the given host and the targets of the respective storage nodes 105 are configured to support one or more designated standard storage access protocols, such as an NVMe access protocol or a SCSI access protocol. As more particular examples in the NVMe context, the designated storage access protocol utilized in some embodiments may comprise an NVMe-oF, NVMe/TCP or NVMe/FC access protocol, although a wide variety of additional or alternative storage access protocols can be used in other embodiments.

The hosts 101 can comprise additional or alternative components. For example, in some embodiments, the hosts 101 further comprise respective sets of host-side IO queues and respective multi-path input-output (MPIO) drivers. The MPIO drivers collectively comprise a multi-path layer of the hosts 101. Path selection functionality for delivery of IO operations from the hosts 101 to the distributed storage system 102 is provided in the multi-path layer by respective instances of path selection logic 114 implemented within the MPIO drivers. In some embodiments, the instances of path selection logic 114 are implemented at least in part within the MPIO drivers of the hosts 101.

The MPIO drivers may comprise, for example, otherwise conventional MPIO drivers, such as PowerPath® drivers from Dell Technologies, suitably modified in the manner disclosed herein to provide one or more portions of the disclosed functionality for application-aware QoS. Other types of MPIO drivers from other driver vendors may be suitably modified to incorporate one or more portions of the functionality for application-aware QoS as disclosed herein.

For example, the instances of path selection logic 114 of the respective hosts 101 can be implemented at least in part in respective MPIO drivers of those hosts.

In some embodiments, such instances of path selection logic 114 include or are otherwise associated with respective corresponding instances of host-side IO processing logic that are configured to receive, for a plurality of targets of the distributed storage system 102, corresponding discovery log pages, to extract from the received discovery log pages respective IP addresses for respective ones of the targets, and to control path selection for delivery of IO operations from a corresponding one of the hosts 101 to the targets based at least in part on the extracted IP addresses of the respective targets.

Such host-side IO processing logic can be part of an MPIO layer of the hosts 101, and possibly deployed at least in part within a corresponding instance of path selection logic 114 in the MPIO layer, or can be implemented elsewhere within the hosts 101.

In some embodiments, the hosts 101 comprise respective local caches, implemented using respective memories of those hosts. A given such local cache can be implemented using one or more cache cards. A wide variety of different caching techniques can be used in other embodiments, as will be appreciated by those skilled in the art. Other examples of memories of the respective hosts 101 that may be utilized to provide local caches include one or more memory cards or other memory devices, such as, for example, an NVMe over PCIe cache card, a local flash drive or other type of NVM storage drive, or combinations of these and other host memory devices.

The MPIO drivers are illustratively configured to deliver IO operations selected from their respective sets of host-side IO queues to the distributed storage system 102 via selected ones of multiple paths over the network 104. The sources of the IO operations stored in the sets of host-side IO queues illustratively include respective processes of one or more applications executing on the hosts 101. For example, IO operations can be generated by each of multiple processes of a database application running on one or more of the hosts 101. Such processes issue IO operations for delivery to the distributed storage system 102 over the network 104. Other types of sources of IO operations may be present in a given implementation of system 100.

A given IO operation is therefore illustratively generated by a process of an application running on a given one of the hosts 101, and is queued in one of the IO queues of the given host with other operations generated by other processes of that application, and possibly other processes of other applications.

The paths from the given host to the distributed storage system 102 illustratively comprise paths associated with respective initiator-target pairs, with each initiator comprising, for example, a port of a single-port or multi-port host bus adaptor (HBA) or other initiating entity of the given host and each target comprising a port or other targeted entity corresponding to one or more of the storage devices 106 of the distributed storage system 102. As noted above, the storage devices 106 illustratively comprise LUNs or other types of logical storage devices.

In some embodiments, the paths are associated with respective communication links between the given host and the distributed storage system 102 with each such communication link having a negotiated link speed. For example, in conjunction with registration of a given HBA to a switch of the network 104, the HBA and the switch may negotiate a link speed. The actual link speed that can be achieved in practice in some cases is less than the negotiated link speed, which is a theoretical maximum value.

Negotiated rates of the respective particular initiator and the corresponding target illustratively comprise respective negotiated data rates determined by execution of at least one link negotiation protocol for an associated one of the paths.

In some embodiments, at least a portion of the initiators comprise virtual initiators, such as, for example, respective ones of a plurality of N-Port ID Virtualization (NPIV) initiators associated with one or more Fibre Channel (FC) network connections. Such initiators illustratively utilize NVMe arrangements such as NVMe/FC, although other protocols can be used. Other embodiments can utilize other types of virtual initiators in which multiple network addresses can be supported by a single network interface, such as, for example, multiple media access control (MAC) addresses on a single network interface of an Ethernet network interface card (NIC). Accordingly, in some embodiments, the multiple virtual initiators are identified by respective ones of a plurality of media MAC addresses of a single network interface of a NIC. Such initiators illustratively utilize NVMe arrangements such as NVMe/TCP, although again other protocols can be used.

Accordingly, in some embodiments, multiple virtual initiators are associated with a single HBA of a given one of the hosts 101 but have respective unique identifiers associated therewith.

Additionally or alternatively, different ones of the multiple virtual initiators are illustratively associated with respective different ones of a plurality of virtual machines of the given host that share a single HBA of the given host, or a plurality of logical partitions of the given host that share a single HBA of the given host.

Numerous alternative virtual initiator arrangements are possible, as will be apparent to those skilled in the art. The term “virtual initiator” as used herein is therefore intended to be broadly construed. It is also to be appreciated that other embodiments need not utilize any virtual initiators. References herein to the term “initiators” are intended to be broadly construed, and should therefore be understood to encompass physical initiators, virtual initiators, or combinations of both physical and virtual initiators.

Various scheduling algorithms, load balancing algorithms and/or other types of algorithms can be utilized by the MPIO driver of the given host in delivering IO operations from the IO queues of that host to the distributed storage system 102 over particular paths via the network 104. Each such IO operation is assumed to comprise one or more commands for instructing the distributed storage system 102 to perform particular types of storage-related functions such as reading data from or writing data to particular logical volumes of the distributed storage system 102. Such commands are assumed to have various payload sizes associated therewith, and the payload associated with a given command is referred to herein as its “command payload.”

A command directed by the given host to the distributed storage system 102 is considered an “outstanding” command until such time as its execution is completed in the viewpoint of the given host, at which time it is considered a “completed” command. The commands illustratively comprise respective NVMe commands, although other command formats, such as SCSI command formats, can be used in other embodiments. In the SCSI context, a given such command is illustratively defined by a corresponding command descriptor block (CDB) or similar format construct. The given command can have multiple blocks of payload associated therewith, such as a particular number of 512-byte SCSI blocks or other types of blocks. Other command formats, e.g., Submission Queue Entry (SQE), are utilized in the NVMe context.

In illustrative embodiments to be described below, it is assumed without limitation that the initiators of a plurality of initiator-target pairs comprise respective ports of the given host and that the targets of the plurality of initiator-target pairs comprise respective ports of the distributed storage system 102. The host ports can comprise, for example, ports of single-port HBAs and/or ports of multi-port HBAs, or other types of host ports, including network interface cards (NICs). A wide variety of other types and arrangements of initiators and targets can be used in other embodiments.

Selecting a particular one of multiple available paths for delivery of a selected one of the IO operations from the given host is more generally referred to herein as “path selection.” Path selection as that term is broadly used herein can in some cases involve both selection of a particular IO operation and selection of one of multiple possible paths for accessing a corresponding logical device of the distributed storage system 102. The corresponding logical device illustratively comprises a LUN or other logical storage volume to which the particular IO operation is directed.

It should be noted that paths may be added or deleted between the hosts 101 and the distributed storage system 102 in the system 100. For example, the addition of one or more new paths from the given host to the distributed storage system 102 or the deletion of one or more existing paths from the given host to the distributed storage system 102 may result from respective addition or deletion of at least a portion of the storage devices 106 of the distributed storage system 102.

Addition or deletion of paths can also occur as a result of zoning and masking changes or other types of storage system reconfigurations performed by a storage administrator or other user. Some embodiments are configured to send a predetermined command from the given host to the distributed storage system 102, illustratively utilizing the MPIO driver, to determine if zoning and masking information has been changed. The predetermined command can comprise, for example, a log sense command, a mode sense command, a “vendor unique command” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the distributed storage system 102 as well to discover the disappearance of any existing LUNs that have been deleted from the distributed storage system 102.

The MPIO driver of the given host in some embodiments comprises a user-space portion and a kernel-space portion. The kernel-space portion of the MPIO driver may be configured to detect one or more path changes of the type mentioned above, and to instruct the user-space portion of the MPIO driver to run a path discovery scan responsive to the detected path changes. Other divisions of functionality between the user-space portion and the kernel-space portion of the MPIO driver are possible. The user-space portion of the MPIO driver is illustratively associated with an Operating System (OS) kernel of the given host.

For each of one or more new paths identified in the path discovery scan, the given host may be configured to execute a host registration operation for that path. The host registration operation for a given new path illustratively provides notification to the distributed storage system 102 that the given host has discovered the new path.

As indicated previously, the storage nodes 105 of the distributed storage system 102 process IO operations from one or more hosts 101 and in processing those IO operations run various storage application processes that generally involve interaction of that storage node with one or more other ones of the storage nodes.

The manner in which functionality for application-aware QoS is implemented in system 100 in some embodiments, utilizing hosts 101 and storage nodes 105, will now be described in more detail.

As noted above, in software-defined storage system arrangements utilizing advanced storage access protocols such as NVMe-oF or NVMe/TCP, and in numerous other distributed storage system contexts, it can be unduly difficult to achieve desired service levels across certain processing resources of one or more storage targets of the storage nodes. For example, conventional approaches can lead to sub-optimal arrangements when processing IO operations utilizing certain resources of one or more storage targets, thereby adversely impacting storage system performance.

Illustrative embodiments disclosed herein provide technical solutions to these and other problems of conventional practice. More particularly, illustrative embodiments provide techniques for application-aware QoS in a distributed storage system. Such techniques in some embodiments can provide improved processing of IO operations, for example, in a software-defined storage system or other distributed storage system comprising one or more clusters of storage nodes. In some embodiments, each such storage node implements at least one storage server.

The disclosed techniques in some embodiments advantageously facilitate highly efficient operation of multiple distinct storage servers implemented in the storage nodes, in processing IO operations received from different applications of multiple hosts that share access to the storage servers of those storage nodes.

For example, some embodiments prevent large bursts of IOs from a low-priority application from unduly delaying the processing of more critical IO operations from a high-priority application by a given storage server of a storage node. Similar operating enhancements are provided in numerous other contexts, leading to significantly improved overall storage system performance.

In some embodiments, a storage target provides a storage system frontend to which hosts connect when using the NVMe protocol. A given storage target, referred to in some embodiments herein as a storage data target (SDT), illustratively provides a mechanism allowing hosts to discover IO-related IP addresses and to manage IO connectivity using those IP addresses. The given storage target receives a given IO operation comprising read and/or write requests from a host and forwards it to a protocol layer of the corresponding storage node. In conjunction with processing of the IO operation, data for one or more read requests and/or acknowledgements for one or more write requests are returned from the storage target to the host.

In some embodiments, a distributed storage system processes IOs from many different host applications, where IO service times of some applications are more critical than those of the other applications. For example, if the same storage system serves a real-time trading platform and also a back office application, the host and/or storage administrators may want to guarantee that the real-time trading platform receives faster IO service times than the back office application, during specified trading hours. Accordingly, the administrators would like to be able to define an application-aware QoS configuration based on operating hours.

In an example multi-tenancy arrangement, a software-defined storage system is shared by multiple host applications, possibly executing on different host devices. The host applications push IOs to one or more storage data clients (SDCs) of their corresponding host devices, and each such SDC pushes IOs to multiple storage data servers (SDSs) of the storage nodes, illustratively via one or more of the above-described SDTs. Multiple processing threads may be used in each storage node. The IOs generally end up in one or more queues and are processed as they were received. The one or more queues generally serve all the received IOs without application awareness.

Assume by way of example that there are two applications, denoted Application A and Application B, and that Application B is much more time critical compared to Application A. Further assume that Application A has a very heavy IO load such that Application B cannot be consistently served within its desired service time. In many such situations, the distributed storage system software is limited by the number of available CPU cycles. In other words, the distributed storage system software is “CPU bound.”

As indicated above, illustrative embodiments herein provide technical solutions to these and other problems that can arise in a distributed storage system which services IOs from multiple distinct host applications. For example, some embodiments are configured to distribute CPU cycles in each storage node among the IOs of the different applications so as to introduce a bias in IO servicing within the storage node based at least in part on the particular QoS requirements of the different host applications. In these and other embodiments, QoS can be defined at an application level and/or at a user level.

In some embodiments, application-aware QoS is illustratively implemented in the following manner. It is assumed for purposes of illustration only that the distributed storage system 102 comprises at least one cluster of storage nodes 105. Each such cluster in some embodiments illustratively comprises a different subset of the storage nodes 105, and is managed at least in part by a corresponding one of the cluster metadata managers 112. For example, first and second clusters may comprise respective local and remote clusters of storage nodes in a given implementation of distributed storage system 102.

Each such storage node includes one or more storage targets, also referred to herein as simply “targets,” that are utilized in processing IO operations received from one or more of the hosts 101. In some embodiments, such targets can additionally or alternatively be used in processing IO operations associated with one or more data services carried out, for example, between first and second clusters.

At least one processing device of the system 100, which may comprise, for example, at least one processing device implementing at least a portion of the distributed storage system 102, such as a particular one of the storage nodes 105 via its corresponding one of the storage processors 108, is configured to implement multiple queues for respective different service levels in a storage target of the storage node. For each of a plurality of IO operations received in the storage target from at least one host device, the at least one processing device determines application-identifying information for the IO operation, identifies a particular one of the queues based at least in part on the application-identifying information for the IO operation, and enqueues the IO operation in the particular identified queue. The at least one processing device is further configured to monitor service times for IO operations processed from the queues, and responsive to detection of an above-threshold deviation from a specified service time objective for a given one of queues, to adjust one or more characteristics of a processing resource time slice allocated for processing of IO operations from the given one of the queues.

In some embodiments, the storage target illustratively comprises at least a portion of a storage frontend of a particular one of the storage nodes 105 of the distributed storage system 102. The particular storage node in such an embodiment further comprises a storage backend that illustratively includes at least one storage server and a plurality of local storage devices. The storage target of the storage frontend of the storage node in some embodiments comprises at least one NVMe controller of the distributed storage system 102, although other types of storage targets could additionally or alternatively be used.

In some embodiments, the application-identifying information for the IO operation comprises at least one of an application identifier, a process identifier, a user identifier and a group identifier. Additional or alternative application-identifying information can be used in other embodiments.

The application-identifying information in some embodiments is illustratively configured to allow the storage target to distinguish between IO operations generated by respective different applications executing on the at least one host device.

In some embodiments, the at least one host device implements at least one SDC that associates each of the IO operations with its respective corresponding application-identifying information.

The different service levels for respective ones of the queues in some embodiments illustratively comprise respective different IO processing criticality levels.

In some embodiments, the at least one processing device is further configured to assign different processing resource time slices to different ones of the queues.

Additionally or alternatively, adjusting one or more characteristics of a processing resource time slice allocated for processing of IO from the given one of the queues comprises adjusting at least one of a number of processing threads and a number of processor cycles of the processing resource time slice.

For example, a time slice allocation comprising a particular number of processing threads and/or a particular number of processor cycles may be increased for the given queue relative to the corresponding allocations of the other queues, to thereby provide the given queue with a greater share of the available processing resources. This reallocation of processing resources among the queues will tend to eliminate the detected above-threshold deviation over time.

In some embodiments, monitoring service times for IO operations processed from the queues comprises determining for each of the queues an average service time over a designated time period. Such determinations of average service time in some embodiments can be performed by a background thread implemented in the corresponding storage node, and may involve periodically computing the average service time for processing of IO operations for each queue in each of a plurality of time periods. These and other periods of time can be fixed or variable, and terms such as “period,” “periodic” and “periodically” as used herein are therefore intended to be broadly construed and should not be viewed as limited, for example, to particular recurring time periods of fixed duration.

Additional or alternative monitoring arrangements, illustratively involving average service times, maximum service times and/or other QoS metrics, can be implemented in other embodiments. Also, other additional or alternative QoS metrics that may be utilized in some embodiments in addition to or in place of service time metrics include, for example, IO operations per second (IOPS) metrics, bandwidth metrics (e.g., MB per second, GB per second, etc.) and numerous others.

In some embodiments, an administrator can define multiple service criticality levels, with each such service criticality level being associated with a different maximum and/or average service time. For example, the administrator can define the different service criticality levels in terms of maximum service times in milliseconds (ms), illustratively as follows:
Low: Maximum service time=100 ms
Normal: Maximum service time=30 ms
Critical: Maximum service time=2 ms

Additionally or alternatively, the administrator in some embodiments can define multiple application criticality levels, possibly for different instances of the same application, illustratively on the basis of distinct processes, users and/or storage volumes.

For example, application criticality levels can be defined on a process, user group and storage volume basis as follows for two distinct portions of Application A denoted Application A1 and Application A2:
Application A1: Process name 1, User Group G1, Volumes V1, V2: Service Level Normal
Application A2: Process name 2, User Group G2, Volume V3: Service Level Critical

A wide variety of additional or alternative parameters can be specified for different applications or portions and/or instances thereof, such as time of day, day of week, week of month, etc.

For example, a given administrator may specify that Application A is critical in certain hours of certain days, and that Application B is critical at other hours of the same or different days.

Additionally or alternatively, one user (e.g., User X) may be more critical than another user (e.g., User Y), even for access to the same storage volume. For example, a particular storage volume may be shared by multiple VMs, where there is a need to prioritize the access of one VM to the storage volume over that of another VM. Illustrative embodiments herein can therefore provide QoS based on application and/or user, as well as additional or alternative application-identifying information.

In some embodiments, the disclosed application-aware QoS functionality is illustratively deployed at least in part as follows.

The above-noted SDC is illustratively implemented as a kernel driver of a corresponding host device, and therefore can determine for a given IO its corresponding parameters such as process name, user identifier and/or user group, and relevant storage volumes. For example, such parameters can be accessed by the SDC in a Linux task_struct data structure of the host device in some embodiments, as is described in more detail elsewhere herein. Other types of data structures can be used in other embodiments.

As previously described, each service criticality level is associated with a different maximum service time, although additional or alternative metrics can be used to define service criticality levels in other embodiments. Moreover, different applications are illustratively associated with different ones of the service criticality levels, in some cases based at least in part on process name, user group and/or storage volumes, also as previously described.

In addition, between each SDC of the host devices and each SDS of each storage nodes, multiple queues are created for each of the defined service criticality levels. IOs associated with a given one of the service criticality levels are directed into the corresponding one of the multiple queues.

The SDS in processing the IOs from the queues in some embodiments illustratively implements the following example algorithm:
1. When service time of all tenant applications is within corresponding designated limits for their respective service criticality levels, continue to process IOs in the normal manner.
2. When service time of at least a given one of the tenant applications is above its maximum, or otherwise exhibits an above-threshold deviation from a specified service time objective, increase a processing resource time slice allocated to the corresponding one of the queues. This can involve increasing a number of processing threads and/or a number of CPU cycles that are utilized to process IOs from the corresponding queue, relative to corresponding time slice allocations of the other queues. Accordingly, the particular share of available resources allocated to the queue for which the above-threshold deviation from a specified service time objective was detected is increased, with corresponding decreases to the shares of available resources allocated to one or more of the other queues. In some embodiments, the time slice based allocation of processing resources is implemented as a variation of weighted fair queuing or another queuing algorithm configured to ensure that IO processing resources are distributed among the multiple service queues based on dynamically-adjustable weights.
3. If the desired service time is still not achieved over a particular period of time despite the increased processing resource time slice, the system can further increase the processing resource time slice and/or raise an alarm to inform the administrator.

Additional or alternative steps can be used in other embodiments, and certain steps shown as being performed serially in the foregoing example can instead be performed at least in part in parallel with each other in other embodiments. Also, similar algorithms can be implemented at least in part in other parts of the storage node, such as at least in part in one or more SDTs of the storage node.

In some embodiments, a user dashboard is provided for utilization by host and/or storage administrators as well as other users. Such a user dashboard can comprise, for example, a management and orchestration dashboard for the distributed storage system. The user dashboard illustratively presents information such as the applications running on the corresponding hosts, their corresponding process names, user groups and/or storage volumes, their designated criticality levels, and their achieved performance relative to the corresponding maximum service time and/or one or more other QoS metrics.

The user interface is illustratively configured to allow authorized users to designate the above-noted service criticality levels and to specify particular ones of the service criticality levels for different ones of the applications, illustratively based on parameters such as process name, user group, storage volume, time periods, etc. The user interface can present IO statistics maintained by the system on a process name, user group and/or storage volume basis.

Also, the SDCs in some embodiments can report average service time for each application and/or process, user group or storage volumes thereof, to the above-described user interface, which is illustratively deployed under the control of one or more system management nodes, which may include metadata managers of the storage system.

The system in some embodiments is also illustratively configured to detect various conditions and to report such detected conditions via the user interface. For example, the system can be configured to detect conditions such as situations in which specified QoS levels are not met and/or situations in which a non-critical tenant application floods the system with IOs. These and other similar conditions can be reported via the user interface.

Illustrative embodiments disclosed herein can provide significant advantages over conventional approaches.

For example, such embodiments can provide an end-to-end application-aware QoS solution in software-defined storage system or other distributed storage system.

This example solution provides a high degree of flexibility in terms of specifying different service criticality levels for different applications, illustratively on the basis of parameters such as process name, user group and/or storage volumes, as well as on time such as time of day, day of the week, week of the month, etc.

These and other embodiments can ensure that QoS requirements are met for numerous different types of host applications that share a given distributed storage system. For example, the disclosed arrangements can ensure that a non-critical tenant application cannot flood the storage system with IOs in a manner that interferes with the processing of IOs from more critical applications.

Again, it is to be appreciated that references in the above description and elsewhere herein to software-defined storage systems comprising SDCs, SDSs and SDTs are presented by way of example only, and other embodiments can utilize numerous other types and arrangements of host devices, storage clients, storage servers, storage targets and storage nodes, in a wide variety of different types of storage systems.

As indicated above, in some embodiments, a given one of the storage targets comprises at least one NVMe controller of the distributed storage system 102, although other types of storage targets can be used, in any combination. The storage targets in some embodiments therefore illustratively comprise respective NVMe targets, each of which may comprise one or more NVMe controllers of the distributed storage system 102. The NVMe targets store data of a plurality of logical storage volumes illustratively comprising respective NVMe namespaces. Other types of storage targets and logical storage volumes can be used in other embodiments.

Additional aspects of some illustrative embodiments will now be described.

Each of one or more of the storage targets of the distributed storage system 102 in some embodiments is configured to operate as a host-storage interface to handle IO operations received in the storage target from one or more of the hosts 101, and possibly also as a data mobility interface to handle IO operations generated as part of one or more data services, such as replication, migration and/or copying, carried out between multiple clusters of the distributed storage system 102. The IO processing loads of the respective storage targets of the distributed storage system 102 therefore illustratively include at least processing of IO operations received in the storage targets from the one or more hosts 101.

In some embodiments, a host receives, for each of multiple storage targets of the distributed storage system 102, corresponding discovery log pages, illustratively from one or more discovery controllers which in some embodiments are implemented on one or more of the multiple targets and/or on at least one different target that is not part of the multiple targets, although other arrangements are possible. In some embodiments, the discovery log pages are illustratively obtained using commands of a storage access protocol, such as an NVMe access protocol, including NVMe-oF or NVMe/TCP, although the disclosed techniques are applicable for use with other storage access protocols, including SCSI and iSCSI access protocols. The term “discovery log page” as used herein is therefore intended to be broadly construed, as illustratively comprising, for example, at least one log page or a suitable portion thereof that includes one or more entries comprising information utilized by the host to discover and connect to the corresponding target, and should not be viewed as being limited to a particular type of log page configured in accordance with a particular storage access protocol.

Additional details regarding NVMe discovery log pages and other aspects of the NVMe standard can be found in, for example, the above-cited NVM Express Base Specification, Revision 2.0c, October 2022, and its associated NVM Express Command Set Specification and NVM Express TCP Transport Specification, although other NVMe implementations can be used.

As mentioned above, each of the storage nodes 105 of the distributed storage system 102 illustratively comprises one or more targets, where each such target is associated with multiple distinct paths from respective HBAs or other initiators of one or more of the hosts 101.

For example, in some embodiments, one or more of the storage nodes 105 each implements at least one target, such as an NVMe target, that is configured to include multiple controllers, such as at least a first controller associated with a first storage pool, and a second controller associated with a second storage pool. The first and second storage pools are illustratively storage pools of the distributed storage system 102, and such storage pools may be distributed across multiple ones of the storage nodes 105. Each of the first and second storage pools is assumed to comprise one or more LUNs or other logical storage volumes.

Although first and second controllers are referred to in conjunction with some embodiments herein, it is to be appreciated that more than two controllers can be implemented in a given target in order to support more than two storage pools.

A given one of the storage nodes 105 illustratively processes IO operations received from one or more of the hosts 101, with different ones of the IO operations being directed by the one or more hosts 101 from one or more initiators of the one or more hosts 101 to different ones of the first and second controllers of the target implemented within the given storage node.

In some embodiments, each of the storage-side IO queues or set of storage-side IO queues configured in the distributed storage system 102 for the given target is associated with at least one corresponding different TCP connection between the given host and the given target.

The given target may comprise at least one NVMe controller of a particular one of the storage nodes 105 of the distributed storage system 102, although other types of targets can be used.

Terms such as “storage target” and “target” as used herein in the context of a distributed storage system or other type of storage system are intended to be broadly construed. As indicated previously, storage targets in some embodiments are also referred to herein as simply “targets.”

The target in some embodiments more particularly comprises multiple controllers accessible via respective different associations comprising one or more TCP connections between the given host and the given storage node. For example, the target may comprise a plurality of NVMe controllers of an NVMe subsystem of the given storage node.

In some embodiments, an NVMe target illustratively comprises one or more NVMe controllers, each having a set of TCP connections associated with an administrative (“Admin”) queue and one or more IO queues. Each TCP connection illustratively corresponds to a single queue having associated request/response entries. In some embodiments, the TCP connections corresponding to a given Admin queue and a set of one or more IO queues are collectively referred to as a “TCP association.” Typically, a fixed number of IO queues are established, with a corresponding fixed number of TCP connections, in accordance with maximum load requirements of one or more applications that will be directing IO operations to the NVMe target for processing. The IO queues and their corresponding TCP connections are examples of what are more generally referred to herein as “network resources.” Such network resources in some embodiments are illustratively used to receive IO operations directed to targets of a storage system from initiators of one or more host devices. Additional or alternative network resources can be used in other embodiments.

As indicated above, in some embodiments, multiple controllers are part of a single physical controller subsystem of the given storage node. For example, first and second controllers may comprise respective NVMe controllers of an NVMe subsystem of the given storage node. Such an NVMe subsystem is considered an example of what is more generally referred to herein as a “storage target” or “target” of the given storage node. A wide variety of other types and arrangements of storage targets can be used in other embodiments.

The first and second controllers in some embodiments may be viewed as comprising respective “virtual” controllers associated with the single physical controller subsystem of the given storage node.

Additionally or alternatively, the first and second controllers in some embodiments are accessible via respective first and second different associations comprising one or more TCP connections between a given one of the one or more hosts 101 and the given storage node. In such an arrangement, a host accesses the first controller using the first association, and accesses the second controller using the second association. Such associations are also referred to herein as TCP associations, and may include, for each of at least one Admin queue and a plurality of IO queues, a corresponding TCP connection. Other types of communication links can be used in other embodiments.

In some embodiments, the first controller comprises a first set of IO queues and the second controller comprises a second set of IO queues, for use in processing IO operations for their respective storage pools. Again, each IO queue in a given such set of IO queues may be associated with a separate TCP connection over which a given one of the hosts 101 communicates with the corresponding controller.

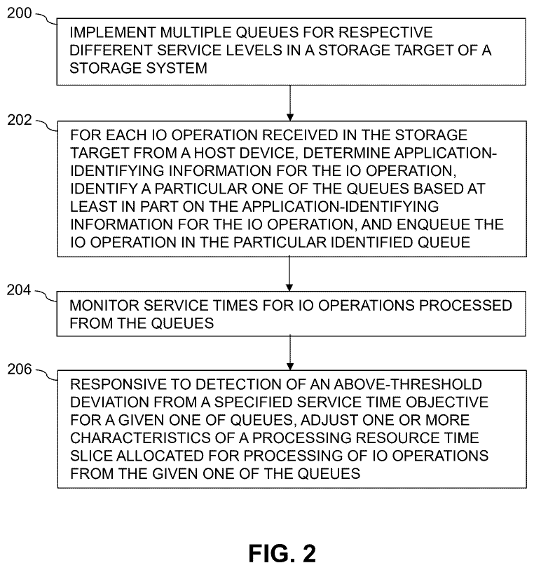

An additional example of an illustrative process for implementing at least some of the above-described functionality for application-aware QoS will be provided below in conjunction with the flow diagram of FIG. 2.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes, including combinations of multiple storage clusters.

Also, the term “storage volume” as used herein is intended to be broadly construed, and should not be viewed as being limited to any particular format or configuration, such as namespaces or LUNs.

The storage nodes 105 of the example distributed storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated hosts 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the hosts 101 and the storage nodes 105 to reside in different data centers. Numerous other distributed implementations of the storage nodes 105 and their respective associated sets of hosts 101 are possible.

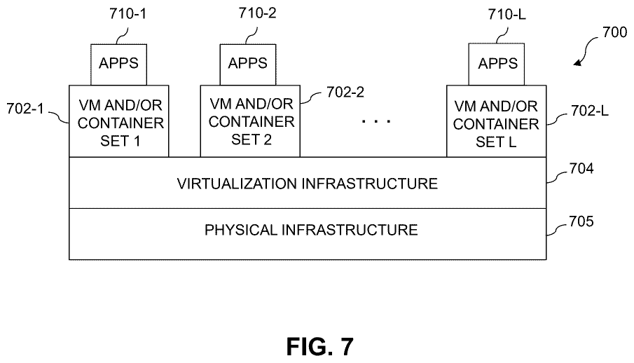

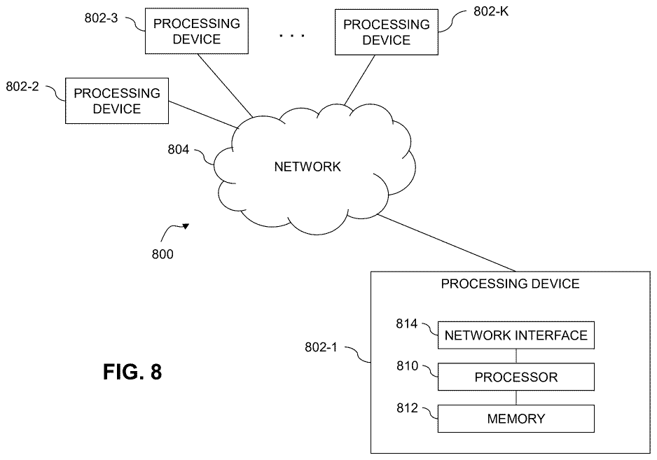

Additional examples of processing platforms utilized to implement storage systems and possibly their associated hosts in illustrative embodiments will be described in more detail below in conjunction with FIGS. 7 and 8.

It is to be appreciated that these and other features of illustrative embodiments are presented by way of example only, and should not be construed as limiting in any way.

The particular features described above in conjunction with FIG. 1 should therefore not be construed as limiting in any way, and a wide variety of other system arrangements implementing application-aware QoS as disclosed herein are possible.

Accordingly, different numbers, types and arrangements of system components such as hosts 101, distributed storage system 102, storage nodes 105, storage devices 106, storage processors 108, system management nodes 110, cluster metadata managers 112, path selection logic 114 and system management database 116 can be used in other embodiments. For example, as mentioned previously, system management functionality of the cluster metadata managers 112 of the system management nodes 110 can be distributed across a subset of the storage nodes 105, instead of being implemented on separate nodes.

It should therefore be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in other embodiments, certain portions of the functionality for application-aware QoS as disclosed herein can be implemented in one or more hosts, in a storage system, or partially in a host and partially in a storage system. Accordingly, illustrative embodiments are not limited to arrangements in which functionality for application-aware QoS is implemented primarily in storage system or primarily in a particular host or set of hosts, and therefore such embodiments encompass various alternative arrangements, such as, for example, an arrangement in which the functionality is distributed over one or more storage systems and one or more associated hosts, each comprising one or more processing devices, and possibly involving one or more separate management nodes. The term “at least one processing device” as used herein is therefore intended to be broadly construed.

The operation of the information processing system 100 will now be described in further detail with reference to the flow diagram of the illustrative embodiment of FIG. 2, which illustrates a process for application-aware QoS as disclosed herein. This process may be viewed as an example algorithm implemented at least in part by distributed storage system 102 interacting with one or more of the hosts 101 and one or more of the system management nodes 110. These and other algorithms for application-aware QoS as disclosed herein can be implemented using other types and arrangements of system components in other embodiments.

The process illustrated in FIG. 2 includes steps 200 through 206, and in some implementations is performed primarily by a given one of the storage nodes 105 via its corresponding one of the storage processors 108. Similar processes may be performed primarily by respective other ones of the storage nodes 105 via their respective storage processors 108, although it is to be appreciated that numerous other implementations are possible in other embodiments.

In step 200, multiple queues are implemented for respective different service levels in a storage target of a storage system. The different service levels for respective ones of the queues illustratively comprise respective different IO processing criticality levels, also referred to herein as respective QoS levels, and may comprise levels such as low criticality, normal criticality and high criticality. Each of these service levels in some embodiments has a different maximum service time or other QoS metric associated therewith. For example, the low criticality level may have a maximum service time of 100 ms, the normal criticality level may have a maximum service time of 30 ms, and the high criticality level, also referred to herein as a “critical level,” may have a maximum service time of 2 ms. These service times may be expressed in other ways, such as using average service times over specified time periods. A wide variety of different types and arrangements of service levels and associated QoS metrics can be used in other embodiments.

The multiple queues implemented for the respective different service levels may be within or otherwise accessible to the storage targets. In some embodiments, these multiple queues of a storage target are referred to as storage-side IO queues. The queues in some embodiments may be considered part of “network resources” within or otherwise associated with a storage target. Terms such as “multiple queues implemented for respective different service levels in a storage target” as used herein are intended to be broadly construed, and should not be viewed as being limited in any way to particular types or arrangements of IO queues. For example, the queues in some embodiments may be external to the storage target, but are configured to facilitate the provision of application-aware QoS in the storage target.

As indicated elsewhere herein, the term “storage target” as used herein is also intended to be broadly construed, and in some embodiments can comprise, for example, an NVMe subsystem, which is more generally referred to herein as an NVMe target. The NVMe subsystem or other NVMe target in such an arrangement illustratively comprises one or more controllers. In some embodiments, each IO queue has its own separate TCP connection, although other arrangements can be used. The set of TCP connections utilized for respective ones of the IO queues and a corresponding Admin queue of the given target are collectively referred to herein as a “TCP association.” The IO queues and their associated TCP connections are examples of what are more generally referred to herein as “network resources,” and other types of network resources can be used in other embodiments.

In step 202, for each IO operation received in the storage target from a host device, application-identifying information is determined for the IO operation, a particular one of the queues is identified based at least in part on the application-identifying information for the IO operation, and the IO operation is enqueued in the particular identified queue.

The application-identifying information for the IO operation in some embodiments comprises at least one of an application identifier, a process identifier, a user identifier and a group identifier, although additional or alternative application-identifying information can be used in other embodiments. The application-identifying information is illustratively configured to allow the storage target to distinguish between IO operations generated by respective different applications executing on one or more host devices. In some embodiments, a given such host device is illustratively configured to implement at least one storage data client, also referred to herein as an SDC, that associates each of the IO operations with its respective corresponding application-identifying information. Other techniques and/or host device components can be used to associate application-identifying information with respective IO operations in other embodiments.

In step 204, service times are monitored for IO operations processed from the queues. For example, in some embodiments, monitoring service times for IO operations processed from the queues illustratively comprises determining for each of the queues an average service time over a designated time period. Additionally or alternatively, individual service times may be compared to the above-noted maximum service times and/or other QoS metrics associated with the respective different service levels. Such monitoring illustratively makes use of one or more thresholds, such as thresholds indicative of percentage deviation from average service times, maximum service times and/or other QoS metrics. For example, a given such threshold may specify that a corresponding QoS metric should not be exceeded by more than a particular percentage value (e.g., 5%, 10% or 20%). A deviation of such an amount is considered an example of what is more generally referred to herein as “an above-threshold deviation” from a specified service time objective for a given one of the queues. A wide variety of other types and arrangements of single or multiple thresholds can be used in other embodiments, and the term “threshold” as used herein is therefore intended to be broadly construed. For example, the maximum service time itself may be viewed as a threshold, with any increase in service time for one or more IO operations above the maximum service time being an example of an above-threshold deviation from a specified service time objective.

In step 206, responsive to detection of an above-threshold deviation from a specified service time objective for a given one of queues, adjustments are made to one or more characteristics of a processing resource time slice allocated for processing of IO operations from the given one of the queues. In some embodiments, different processing resource time slices are assigned to different ones of the queues. The processing resource time slices may comprise, for example, different numbers and types of processing threads and/or processor cycles (e.g., CPU cycles) of one or more processing resources (e.g., one or more processor cores) of the corresponding storage node.

In some embodiments, adjusting one or more characteristics of a processing resource time slice allocated for processing of IO operations from the given one of the queues comprises illustratively comprises adjusting a number of processing threads and/or a number of processor cycles of the processing resource time slice. For example, a time slice allocation comprising a particular number of processing threads and/or a particular number of processor cycles may be increased for the given queue relative to the corresponding allocations of the other queues, to thereby provide the given queue with a greater share of the available processing resources. This reallocation of processing resources among the queues will tend to eliminate the detected above-threshold deviation over time.

Other types and arrangements of different processing resource time slices and associated adjustments thereof can be used in other embodiments. The term “processing resource time slice” as used herein is therefore intended to be broadly construed, so as to encompass, for example, various arrangements for allocating, at least in part on a time basis, utilization of processing threads, processor cycles and/or other processing resources of a storage node between the multiple queues implemented for the respective different service levels in the storage target.

The processing resource time slices referred to herein are therefore illustratively implemented utilizing one or more storage processors and/or other processing devices of at least one storage node of a distributed storage system. Other types of storage systems, storage targets and associated storage processors can be used in other embodiments.

One or more of steps 200 through 206 are illustratively repeated over time in order to support the functionality for application-aware QoS as disclosed herein. For example, steps 202 through 206 may operate in a substantially continuous loop for a given set of multiple queues implemented in step 200, so as to provide ongoing application-aware QoS for processing of IO operations over time. Additionally or alternatively, multiple such processes may operate in parallel with one another in order to provide functionality for application-aware QoS for different storage nodes and their corresponding storage targets.

The steps of the FIG. 2 process are shown in sequential order for clarity and simplicity of illustration only, and certain steps can at least partially overlap with other steps. Additional or alternative steps can be used in other embodiments.

The particular processing operations and other system functionality described in conjunction with the flow diagram of FIG. 2 are therefore presented by way of illustrative example only, and should not be construed as limiting the scope of the disclosure in any way. Alternative embodiments can use other types of processing operations for implementing application-aware QoS in a system comprising one or more hosts and a storage system. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for respective different storage targets.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

One or more hosts and/or one or more storage nodes can be implemented as part of what is more generally referred to herein as a processing platform comprising one or more processing devices each comprising a processor coupled to a memory.

A given such processing device in some embodiments may correspond to one or more virtual machines or other types of virtualization infrastructure such as Docker containers or Linux containers (LXCs). Hosts, storage processors and other system components may be implemented at least in part using processing devices of such processing platforms. For example, respective path selection logic instances and other related logic instances of the hosts can be implemented in respective containers running on respective ones of the processing devices of a processing platform.

Referring now to FIG. 3, an additional example of an information processing system 300 implementing functionality for application-aware QoS is shown. The system 300 comprises a plurality of host devices 301, denoted as Host 1, Host 2, Host 3, Host 4, Host 5, . . . Host M, and at least one storage cluster comprising a first storage node 305-1 and other storage nodes 305-2 through 305-N. The system 300 is assumed to be a software-defined storage system, and the storage targets in this embodiment illustratively comprise respective storage data targets, also referred to herein as SDTs, as illustrated for the first storage node 305-1. The host devices 301 and the storage nodes 305 communicate with one another over a TCP/IP network 304. Also coupled to the TCP/IP network 304 is a cluster metadata manager 312 of the cluster of storage nodes 305. The storage nodes 305 collectively comprise an example distributed storage system in which one or more example storage targets are implemented on each of the storage nodes 305 shared by the host devices 301. Other embodiments can include additional clusters, host devices, storage targets, cluster metadata managers and/or other processing device based system components.

It is assumed that applications execute on the host devices 301 and generate IO operations that are delivered over the TCP/IP network 304 to particular SDTs of the storage nodes 305, illustratively via respective SDCs of the host devices 301. Each of the SDTs is configured to operate as a host-storage interface to handle IO operations received in the SDT from the SDCs of the host devices 301. Accordingly, the IO processing loads of the respective SDTs of the storage nodes 305 include processing of IO operations received in those respective SDTs from the SDCs of the host devices 301.

In some embodiments, the storage nodes 305 are configured at least in part as respective clusters of PowerFlex™ software-defined storage nodes from Dell Technologies, suitably modified as disclosed herein to implement functionality for application-aware QoS, although it is to be appreciated that other types of storage nodes can be used in other embodiments.

The storage nodes 305 collectively provide a distributed storage system based on the NVMe access protocol. The storage targets in this embodiment comprise multiple NVMe targets, illustratively implemented as respective SDTs, each providing a different storage system interface. Application servers or other host devices can connect to several of the NVMe targets for IO load balancing, bandwidth utilization and congestion avoidance, illustratively utilizing path selection algorithms implemented in MPIO drivers of the type noted above. Moreover, one or more of the SDTs may additionally be configured for use as data mobility interfaces to handle IO operations generated as part of one or more data services.

In some embodiments, in order to utilize NVMe-oF technology, SDTs are configured on respective storage nodes 305 of the system 300, which as indicated above comprises software-defined storage. A given such SDT generally acts as a frontend for its corresponding storage node, providing a host-storage interface to backend storage on that node, and handles functionality such as IO processing and connection discovery services for NVMe hosts configured within the system 300. Some SDTs can additionally or alternatively be utilized in other use cases such as data mobility (e.g., replication, migration, data copy, etc.), where SDTs in a source cluster of the software-defined storage system make IO connections to SDTs in a remote cluster, also referred to as a target cluster of the system, and use those IO connections to transfer data from the source cluster to the target cluster in the system. An SDT can therefore have multiple interfaces and each interface can take one or multiple roles (e.g., host-storage interface and data mobility interface) based on user configuration.

The first storage node 305-1 includes, as at least part of its storage frontend, an SDT 320. The first storage node 305-1 further includes, as at least part of its storage backend, a storage data server or SDS 324 and local storage devices 326. The SDS 324 is illustratively configured to interact with SDCs of the host devices 301 via the SDT 320. The SDT 320 comprises IO processing logic 330, IO service time monitoring & reporting logic 332 and per-queue time slice adjustment logic 334.

It is assumed that each of the other storage nodes 305-2 through 305-N of the system 300 is also configured to include at least one SDT 320, at least one SDS 324 and at least one set of local storage devices 326, arranged in a manner similar to that illustrated for the first storage node 305-1 in the figure.

Multiple queues are implemented in the SDT 320, illustratively comprising a total of Q queues denoted as Service Queue 1, Service Queue 2, . . . Service Queue Q. There is generally one such service queue implemented for each of the different service levels supported by the SDT 320, although other arrangements are possible. Also, the number of service queues can change over time, and the service queues can be implemented at least in part externally to the SDT 320 in other embodiments.

Accordingly, references herein to implementation of service queues for a storage target such as SDT 320 should be understood to encompass arrangements in which the service queues are implemented within the storage target as well as alternative arrangements in which the service queues are implemented in whole or in part externally to the storage target, such as in a storage processor or other processing component of the corresponding storage node, or in an associated memory. The service queues are therefore shown within SDT 320 in the FIG. 3 embodiment by way of illustrative example only, and may instead be implemented externally to the SDT 320 in other embodiments.

In some embodiments, for each of a plurality of IO operations received in the SDT 320 from an SDC of one of the host devices 301, the IO processing logic 330 determines application-identifying information for the IO operation, identifies a particular one of the service queues based at least in part on the application-identifying information for the IO operation, and enqueues the IO operation in the particular identified queue.

The IO service time monitoring & reporting logic 332 monitors service times for IO operations processed from the queues by the SDS 324, illustratively utilizing maximum service times, average service times and/or other QoS metrics, and detects above-threshold deviations from specified service time objectives for each of the service queues, as described in more detail elsewhere herein. Such monitored service times are illustratively reported to the cluster metadata manager 312 or other system management node of the system 300. Other types of reporting may be performed, such as reporting to one or more administrators or other users via a user interface as described elsewhere herein.

Responsive to detection of an above-threshold deviation from a specified service time objective for a given one of queues, the per-queue time slice adjustment logic 334 adjusts one or more characteristics of a processing resource time slice allocated for processing of IO operations from the given one of the queues. For example, a time slice allocation comprising a particular number of processing threads and/or a particular number of processor cycles may be increased relative to the allocations of the other queues, so as to provide the given queue with a greater share of the available processing resources, in a manner that will tend to eliminate the detected above-threshold deviation over time.

In some embodiments, the cluster metadata manager 312 may be involved in maintaining service time information for each of the service queues of the SDT 320. For example, at least portions of the logic components 332 and 334 in some embodiments can be implemented at least in part in the cluster metadata manager 312, or in another component of system 300, rather than in the SDT 320 as illustrated in the figure.

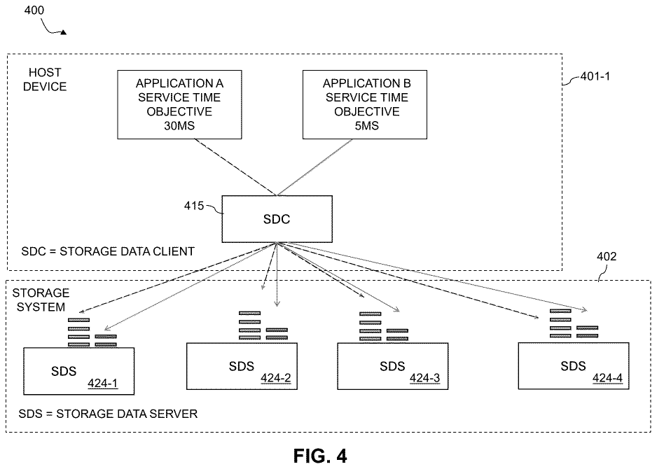

FIG. 4 shows another example of an information processing system 400 with application-aware QoS functionality in an illustrative embodiment. The system 400 comprises at least one host device 401-1 that writes data to and reads data from a storage system 402, illustratively over at least one network that is not explicitly shown in the figure. The host device 401-1 in some embodiments may be one of a plurality of host devices that share access to the storage system 402, with each such host device and/or its associated applications illustratively considered a “tenant” of the storage system 402.

It is assumed in this embodiment that the host device 401-1 implements at least one SDC 415, and that the storage system 402 implements a plurality of SDSs, illustratively including at least SDSs 424-1, 424-2, 424-3 and 424-4. More or fewer such components may be deployed in other embodiments. Different ones of the SDSs 424 may be implemented on respective different storage nodes of the storage system 402, or multiple ones of the SDSs may be implemented on a single storage node.

The host device 401-1 in this embodiment has multiple distinct applications executing thereon, including first and second applications denoted as Application A and Application B, respectively. The different applications have different service criticality levels associated therewith, with Application A having a relatively low service criticality level with a service time objective of 30 ms, and Application B having a relatively high service criticality level with a service time objective of 5 ms. Each of the applications generates IO operations that are delivered via SDC 415 to IO queues of the storage system 402 for processing by particular ones of the SDSs 424 illustratively on different storage nodes.

Assuming by way of example that each of the SDSs 424 is associated with a different storage target of the storage system 402, a set of IO queues deployed for a given such storage target to support application-aware QOS as disclosed herein includes a first queue for IO operations of Application A and a second queue for IO operations of Application B. The set of IO queues from which each of the SDSs 424 selects IO operations for processing is shown above the corresponding SDS, with different stacks of IO operations being used to illustrative the corresponding first and second queues.

Each of the IO operations arriving in a storage target of the storage system 402 from the SDC 415 of the host device 401-1 are processed to determine application-identifying information for the IO operation, to identify a particular one of the first and second queues based at least in part on the application-identifying information for the IO operation, and to enqueue the IO operation in the particular identified queue. Accordingly, IO operations identified by the storage target through the application-identifying information as originating from Application A are enqueued in the first queue, and IO operations identified by the storage target through the application-identifying information as originating from Application B are enqueued in the second queue.

In this embodiment, different portions of available processing resources of each storage node are allocated as respective processing resource time slices to different ones of the first and second queues on each storage node. For example, different numbers of processing threads and/or processor cycles of one or more processors of the storage node are allocated as part of the different processing resource time slices to the respective first and second queues. More particularly, the first queue storing IO operations for Application B is a relatively high priority application and is therefore assigned a greater share of available processing resources via its corresponding time slice than second queue storing IO operations for Application A.

As illustrated in the figure, on a given one of the storage targets associated with a corresponding SDS, the first queue that includes the relatively low-priority IO operations of Application A has a backlog of four IO operations, and the second queue that includes the relatively high-priority IO operations of Application B has a lower backlog, illustratively shown as two IO operations. Such backlogs illustratively arise from the fact that the first and second queues are allocated different time slices, each including different amounts of the available processing resources.

On each of the storage nodes, service times for IO operations processed from the queues are monitored, illustratively on a substantially continuous basis, and adjustments are made in the processing resource time slice allocations responsive to any detected above-threshold deviations from specified service time objectives, as previously described herein, to facilitate achievement of corresponding QoS levels over time.

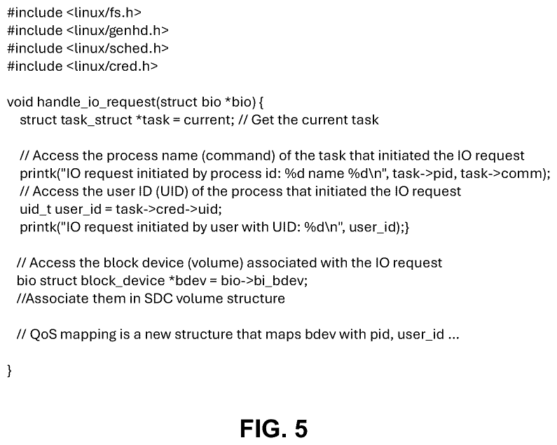

FIG. 5 shows example pseudocode for associating application-identifying information with IO operations in a host device in an illustrative embodiment. More particularly, this example pseudocode is illustratively implemented as part of the kernel code of an SDC such as SDC 415 of the FIG. 4 embodiment.

As indicated previously, such an SDC in some embodiments is implemented as a kernel driver of a corresponding host device, such as a block IO driver or other type of IO driver of the host device, and therefore can determine for a given IO its corresponding parameters such as process name, user identifier and/or user group, and relevant storage volumes. In the present embodiment, it is assumed that such parameters providing application-identifying information are accessed by the SDC in a Linux task_struct data structure of the host device. This allows the SDC to associate the application-identifying information with respective IO operations generated by applications of the host device, where such applications each comprise one or more corresponding application processes executing on the host device. The application-identifying information associated with each host device is then utilized to control enqueuing of the IO operations in different service queues in a storage node of a storage system, as described in more detail elsewhere herein.

The example pseudocode is illustratively performed for each of the IO operations as they are processed by the SDC in the host device, and involves accessing a current version of task_struct for a current task associated with a given IO operation, also referred to in the pseudocode as an IO request. In this example, the pseudocode accesses a process name of the task that initiated the IO request, and accesses a user identifier (“user ID”), also referred to as UID, of the process that initiated the IO request. The pseudocode also accesses the block device, indicating a particular storage volume, associated with the IO request, and associates them in a SDC volume structure as shown. Also as indicated, a QoS mapping structure is used in the present embodiment to map a particular targeted block device (“bdev”) and its IO request with the corresponding application-identifying information such as process identifier (“pid”), user identifier (“user_id”), etc. The SDC volume structure and QoS mapping structure are examples of data structures that are utilized to associate application-identifying information with respective IO operations in illustrative embodiments. It is to be appreciated that different types and configurations of data structures can be used in other embodiments.

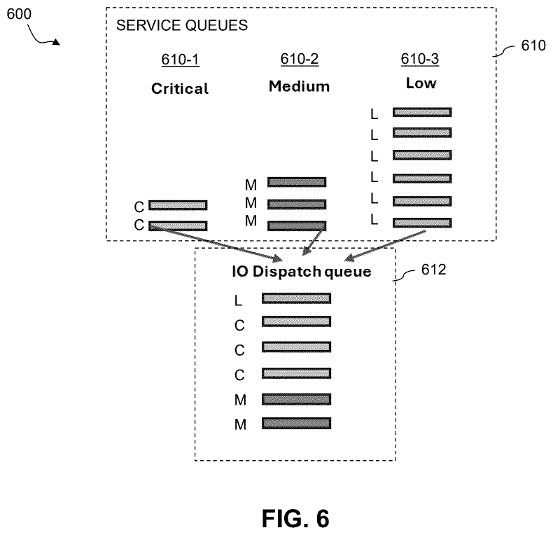

FIG. 6 shows an example queuing arrangement 600 implemented in a storage node of a distributed storage system in an illustrative embodiment. The queuing arrangement 600 in this embodiment more particularly comprises multiple service queues 610, illustratively including three separate service queues 610-1, 610-2 and 610-3 implemented for respective different service levels in a storage target of the storage node. The different service levels in this example include a critical level corresponding to service queue 610-1, a medium or “normal” level corresponding to service queue 610-2, and a low level corresponding to service queue 610-3. Different processing resource time slices are allocated for processing of IO operations from different ones of the multiple service queues 610.

The IO operations, illustratively denoted in the figure utilizing the notation C, M or L for critical, medium or low, respectively, are received in the storage target of the storage node from one or more host devices and are enqueued in different ones of the multiple service queues 610 based at least in part on corresponding application-identifying information associated with those IO operations as described elsewhere herein.

The queuing arrangement 600 further comprises an IO dispatch queue 612. The IO dispatch queue 612 in this embodiment comprises a single queue that receives IO operations selected from each of the service queues 610 for further processing in the storage node. The ordering of the IO operations in the IO dispatch queue illustratively represents an order in which the IO operations are to be further processed, which can be different than an order in which the IO operations are received. More particularly, selection of IO operations from the service queues 610 for inclusion in the IO dispatch queue 612 illustratively takes into account the above-noted different processing resource time slices allocated for processing of IO operations from different ones of the multiple service queues 610, which results in more of the critical IO operations being selected for inclusion in the IO dispatch queue 612 from service queue 610-1 even though there is a larger number of low level IO operations in the service queue 610-3 awaiting further processing in the storage node.

The queuing arrangement 600 in some embodiments implements the time slice based allocation of processing resources as a variation of weighted fair queuing or another queuing algorithm configured to ensure that IO processing resources are distributed among the multiple service queues 610 based on dynamically-adjustable weights. For example, assume there are n service queues based on respective criticality levels, arranged from 1 to n in accordance with highest criticality to lowest criticality, and their respective corresponding processing resource time slices t are given by t₁, t₂, . . . tₙ such that t₁>t₂> . . . >tₙ.

Each such service queue is allocated a different number u of processing threads of one or more processor cores of the corresponding storage node, with the number of processing threads being given by given by u₁, u₂, . . . uₙ such that u₁>u₂> . . . >uₙ. The more critical service queues therefore have more processing threads allocated thereto than the less critical service queues.

In the case of the FIG. 6 queuing arrangement 600 with three service queues 610, the time slice based allocation may be in a ratio of 8 for high to 5 for medium to 2 for low, where the values 8, 5 and 2 may represent respective allocated unit portions of a 15-unit time slice and its corresponding total number of available processing threads.

In these and other embodiments, dequeuing of IO operations from the service queues illustratively follows a rule-based algorithm as follows, again with reference to the example queuing arrangement 600 of FIG. 6:
1. Starting from the first service queue 610-1, dequeue from the service queue until there are no more IO operations in the queue or until an associated allocated time slice based expiration time for the service queue expires, at which point the processing moves to the next service queue. IO operations dequeued from the service queues 610 are enqueued in the IO dispatch queue 612 to await further processing in the storage node.
2. Each of the service queues 610 has a limit on maximum number of IO operations that can be enqueued therein. When the limit is reached for a given service queue, IO operations of the corresponding criticality level may be returned with a busy indication to the requesting host, at which point they can be retried by the host.
3. After the expiration time is reached for the first service queue 610-1, the processing moves to the second service queue 610-2, as indicated above, and similarly for movement of processing from the second service queue 610-2 to the third service queue 610-3. After the expiration time is reached for the last service queue, that is, service queue 610-3 in this example, the processing moves back to the first queue 610-1.
4. The average service times for the IO operations in each service queue are continuously monitored.
5. Responsive to detection of an above-threshold deviation from a specified service time objective for a given one of the service queues, the time slice allocations are adjusted to allocate a greater share of the available processing resources to the given service queue.

Additional or alternative algorithm steps can be used in other embodiments. Also, other embodiments can use different orderings of the steps and/or at least partial overlapping of at least some of the steps.

In some embodiments, the above algorithm above may be temporarily disabled if (i) the number of pending IO operations falls below a threshold number of IO operations for each of the service queues and (ii) the expected service time objectives are being consistently achieved. The service times in such a situation continue to be monitored and the algorithm is illustratively re-enabled responsive to detection of a deviation from either of the conditions (i) and (ii) that led to the temporary disabling of the algorithm.

As indicated previously, the above-described example arrangements advantageously provide an end-to-end application-aware QoS solution in software-defined storage system or other distributed storage system.

These and other embodiments provide a high degree of flexibility in terms of specifying different service criticality levels for different applications, illustratively on the basis of parameters such as process name, user group and/or storage volumes, as well as on time such as time of day, day of the week, week of the month, etc.

Such embodiments advantageously ensure that QoS requirements are met for numerous different types of host applications that share a given distributed storage system. For example, the disclosed arrangements can ensure that a non-critical tenant application cannot flood the storage system with IOs in a manner that interferes with the processing of IOs from more critical applications.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

For example, it is to be appreciated that references in the above description to storage systems comprising SDTs each having multiple associated service queues are presented by way of example only, and other embodiments can utilize numerous other types and arrangements of storage targets and storage nodes comprising multiple service queues, in a wide variety of different types of storage systems.

Multi-pathing portions of the example techniques described above may be performed by a given MPIO driver on a corresponding host device, and similarly by other MPIO drivers on respective other host devices. Such MPIO drivers illustratively form a multi-path layer comprising multi-pathing software of the host devices. Other types of host drivers can be used in other embodiments.

Although particular software-defined storage system configurations are described in conjunction with the embodiments above, the disclosed techniques can be adapted in a straightforward manner for use in a wide variety of other types of storage systems. Accordingly, the disclosed techniques should not be viewed as being restricted in any way to particular storage systems, such as PowerFlex™ storage systems.

Also, storage access protocols other than SCSI and/or NVMe access protocols can be used in other embodiments.

Furthermore, the particular system configurations as shown in FIGS. 3 through 6 are presented by way of illustrative example only, and should not be viewed as limiting in any way. A wide variety of different alternative arrangements of host devices, storage node clusters and metadata managers can be used in other embodiments.

For example, in some embodiments, an information processing system comprises host-side elements that include application processes, path selection logic and IO processing logic, and storage-side elements that include multiple storage targets and IO processing logic. The path selection logic is configured to operate in conjunction with the host-side IO processing logic, the multiple storage targets and the storage-side IO processing logic, and possibly additional components such as one or more cluster metadata managers of one or more system management nodes, to implement functionality for application-aware QoS in the system in the manner disclosed herein. There may be separate instances of one or more such elements associated with each of a plurality of system components such as hosts and storage arrays of the system. For example, different instances of the path selection logic and host-side IO processing logic are illustratively implemented within or otherwise in association with respective ones of a plurality of MPIO drivers of respective hosts. In other embodiments, the host-side IO processing logic can be implemented at least in part within the path selection logic. Numerous other arrangements are possible.

The system in some embodiments may be configured in accordance with a layered system architecture that illustratively includes a host processor layer, an MPIO layer, a host port layer, a switch fabric layer, a storage array port layer and a storage array processor layer. The host processor layer, the MPIO layer and the host port layer are associated with one or more hosts, the switch fabric layer is associated with one or more SANs or other types of networks, and the storage array port layer and storage array processor layer are associated with one or more storage arrays. A given such storage array illustratively comprises a software-defined storage system or other type of distributed storage system comprising a plurality of storage nodes, and may be one of a plurality of clusters of the distributed storage system. In addition, as indicated above, one or more cluster metadata managers of one or more system management nodes may also be associated with such clusters, and configured to implement at least portions of the disclosed functionality for application-aware QoS.

In a manner similar to that described elsewhere herein, one or more storage arrays of the system are each configured to implement one or more storage targets, such as, for example, at least a first controller associated with a first storage pool, and a second controller associated with a second storage pool, where the first and second controllers each include respective sets of IO queues. Numerous other arrangements of multiple targets can be used.

The system in such an embodiment implements functionality for application-aware QoS utilizing one or more MPIO drivers of the MPIO layer, and associated instances of path selection logic and host-side IO processing logic, as well as the multiple storage targets and the storage-side IO processing logic, possibly with one or more cluster metadata managers associated with one or more management nodes. It should be noted in this regard that in some embodiments, functionality of a cluster metadata manager may be implemented at least in part within one or more storage nodes of a given storage cluster, instead of within one or more management nodes.

Although various types of commands and log pages are used in illustrative embodiments herein, other types of commands and log pages can be used in other embodiments. For example, various types of log sense, mode sense and/or other “read-like” commands, possibly including one or more commands of a standard storage access protocol such as the above-noted NVMe and SCSI access protocols, can be used in other embodiments.

These and other features of illustrative embodiments disclosed herein are examples only, and should not be construed as limiting in any way. Other types of application-aware QoS can be used in other embodiments, and the term “application-aware QoS” as used herein is intended to be broadly construed.

Illustrative embodiments of processing platforms utilized to implement hosts and distributed storage systems with functionality for application-aware QoS will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. Such implementations can provide functionality for application-aware QoS in a distributed storage system of the type described above using one or more processes running on a given one of the VMs. For example, each of the VMs can include logic instances and/or other components for implementing functionality associated with application-aware QoS in the system 100.

A hypervisor platform may be used to implement a hypervisor within the virtualization infrastructure 704. Such a hypervisor platform may comprise an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system. Such implementations can also provide functionality for application-aware QoS in a distributed storage system of the type described above. For example, a container host supporting multiple containers of one or more container sets can include logic instances and/or other components for implementing functionality associated with application-aware QoS in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a CPU, a microprocessor, a microcontroller, an application-specific integrated circuit (ASIC), a field-programmable gate array (FPGA), a graphics processing unit (GPU), a neural processing unit (NPU), a data processing unit (DPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application-aware QoS provided by one or more components of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, hosts, storage systems, storage nodes, storage targets, storage processors, path selection logic instances, service level queues and other components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to implement multiple queues for respective different service levels in a storage target of a storage system;
for each of a plurality of input-output operations received in the storage target from at least one host device, to determine application-identifying information for the input-output operation, to identify a particular one of the queues based at least in part on the application-identifying information for the input-output operation, and to enqueue the input-output operation in the particular identified queue;
to monitor service times for input-output operations processed from the queues; and
responsive to detection of an above-threshold deviation from a specified service time objective for a given one of queues, to adjust one or more characteristics of a processing resource time slice allocated for processing of input-output operations from the given one of the queues.

2. The apparatus of claim 1 wherein the storage target comprises at least a portion of a storage frontend of a particular one of a plurality of storage nodes of the storage system.

3. The apparatus of claim 2 wherein the particular storage node further comprises a storage backend that includes at least one storage server and a plurality of local storage devices.

4. The apparatus of claim 1 wherein the storage target comprises at least one Non-Volatile Memory Express (NVMe) controller of the storage system.

5. The apparatus of claim 1 wherein the application-identifying information for the input-output operation comprises at least one of an application identifier, a process identifier, a user identifier and a group identifier.

6. The apparatus of claim 1 wherein the application-identifying information is configured to allow the storage target to distinguish between input-output operations generated by respective different applications executing on the at least one host device.

7. The apparatus of claim 1 wherein the at least one host device implements at least one storage data client that associates each of the input-output operations with its respective corresponding application-identifying information.

8. The apparatus of claim 1 wherein the different service levels for respective ones of the queues comprise respective different input-output processing criticality levels.

9. The apparatus of claim 1 wherein the at least one processing device is further configured to assign different processing resource time slices to different ones of the queues.

10. The apparatus of claim 1 wherein adjusting one or more characteristics of a processing resource time slice allocated for processing of input-output operations from the given one of the queues comprises adjusting at least one of a number of processing threads and a number of processor cycles of the processing resource time slice.

11. The apparatus of claim 1 wherein monitoring service times for input-output operations processed from the queues comprises determining for each of the queues an average service time over a designated time period.

12. A computer program product comprising a non-transitory processor-readable storage medium having stored therein program code of one or more software programs, wherein the program code when executed by at least one processing device comprising a processor coupled to a memory, causes the at least one processing device:
to implement multiple queues for respective different service levels in a storage target of a storage system;
for each of a plurality of input-output operations received in the storage target from at least one host device, to determine application-identifying information for the input-output operation, to identify a particular one of the queues based at least in part on the application-identifying information for the input-output operation, and to enqueue the input-output operation in the particular identified queue;
to monitor service times for input-output operations processed from the queues; and
responsive to detection of an above-threshold deviation from a specified service time objective for a given one of queues, to adjust one or more characteristics of a processing resource time slice allocated for processing of input-output operations from the given one of the queues.

13. The computer program product of claim 12 wherein the application-identifying information for the input-output operation comprises at least one of an application identifier, a process identifier, a user identifier and a group identifier.

14. The computer program product of claim 12 wherein the application-identifying information is configured to allow the storage target to distinguish between input-output operations generated by respective different applications executing on the at least one host device.

15. The computer program product of claim 12 wherein adjusting one or more characteristics of a processing resource time slice allocated for processing of input-output operations from the given one of the queues comprises adjusting at least one of a number of processing threads and a number of processor cycles of the processing resource time slice.

16. A method comprising:
implementing multiple queues for respective different service levels in a storage target of a storage system;
for each of a plurality of input-output operations received in the storage target from at least one host device, determining application-identifying information for the input-output operation, identifying a particular one of the queues based at least in part on the application-identifying information for the input-output operation, and enqueuing the input-output operation in the particular identified queue;
monitoring service times for input-output operations processed from the queues; and
responsive to detection of an above-threshold deviation from a specified service time objective for a given one of queues, adjusting one or more characteristics of a processing resource time slice allocated for processing of input-output operations from the given one of the queues.
wherein the method is performed by at least one processing device comprising a processor coupled to a memory.

17. The method of claim 16 wherein the application-identifying information for the input-output operation comprises at least one of an application identifier, a process identifier, a user identifier and a group identifier.

18. The method of claim 16 wherein the application-identifying information is configured to allow the storage target to distinguish between input-output operations generated by respective different applications executing on the at least one host device.

19. The method of claim 16 wherein adjusting one or more characteristics of a processing resource time slice allocated for processing of input-output operations from the given one of the queues comprises adjusting at least one of a number of processing threads and a number of processor cycles of the processing resource time slice.

20. The method of claim 16 wherein monitoring service times for input-output operations processed from the queues comprises determining for each of the queues an average service time over a designated time period.
